(19) United States
(12) Patent Application Publication
(10) Pub. No.: US 2025/0005070 A1
(43) Pub. Date: Jan. 2, 2025

(54) SYSTEMS AND METHODS FOR MULTIMEDIA DOCUMENT RELATIONAL STORAGE AND RETRIEVAL

(71) Applicant: State Farm Mutual Automobile Insurance Company, Bloomington, IL (US)

(72) Inventors: Christian D. Payne, Peoria, IL (US); Diana Sherwood, Scottsdale, AZ (US); Nuthana Buddha, Chandler, AZ (US); Zaki Goumandakoye, Dublin, CA (US); Joseph Harr, Bloomington, IL (US); Anna Zarkoob, Phoenix, AZ (US); Aarsh Desai, Scottsdale, AZ (US); Michael DiBenedetto, Mesa, AZ (US)

(21) Appl. No.: 18/668,710

(22) Filed: May 20, 2024

Related U.S. Application Data
(60) Provisional application No. 63/510,748, filed on Jun. 28, 2023.

(51) Int. Cl. G06F 16/435; G06F 16/438; G06F 21/60

(52) U.S. Cl. CPC G06F 16/437; G06F 16/4393; G06F 21/604; G06F 2221/2113; G06F 2221/2141

(57) ABSTRACT

A computer system is provided and is programmed to: (1) display, via a first client device, a prompt to a first user; (2) receive, from the first client device, a first response captured by the first client device in response to the prompt; (3) transmit to at least a second client device, a link to view the first response, wherein the second client device is configured to display the first response; (4) receive, from the second client device, a second response captured by the second client device in response to the first response; and/or (5) associate the second response with the first response.

### CROSS-REFERENCE TO RELATED APPLICATIONS

This application claims the benefit of priority of U.S. Provisional Patent Application Ser. No. 63/510,748, filed Jun. 28, 2023, and entitled “SYSTEMS AND METHODS FOR MULTIMEDIA DOCUMENT RELATIONAL STORAGE AND RETRIEVAL,” the contents and disclosures of which are hereby incorporated herein in their entirety.

### FIELD OF THE DISCLOSURE

The field of the disclosure relates generally to systems and methods for providing multimedia document relational storage and retrieval, and more specifically, to a data storage and access system and method that is configured to store multi-media files with annotations and links between the files to facilitate record keeping and/or storing historical information.

### BACKGROUND

The present disclosure relates to multimedia document relational storage and retrieval and, more particularly, to a network-based system and method for determining associations between different types of multimedia files, annotating those files with the associations, and storing the associations and the files so that the associations are provided when retrieved.

Regardless of the level of importance that people may place on capturing and preserving information, there may be a general difficulty in committing to it and to finding a proper tool to assist with this process. Many of the potential solutions that may be used to capture and preserve information may be fragmented and unable to connect many different types of information in different types of files, such as, but not limited to, documents, images, videos, and/or audio files. For at least these reasons, many people do not even attempt to capture and organize such information. It is just too difficult and time consuming.

In many cases, this information (e.g., documents, images, videos, audio files, etc.) may be provided by a plurality of different individuals and may need to be accessible by the plurality of different individuals. In addition, the secure storage and accessibility of this information over a period, in some cases several years, may be necessary. Moreover, it would be useful for the information to be organized for easy retrieval and for easy searching and viewing. Furthermore, the security and integrity of this information is vitally important as well.

Accordingly, a system and method is needed that may enable users to capture, organize, preserve, securely store, search, and view large amounts of information included within a variety of different types of data files over an extended period of time. Conventional techniques may include additional inefficiencies, ineffectiveness, encumbrances, and/or other drawbacks, as well.

### BRIEF DESCRIPTION

The present embodiments may also relate to systems and methods for memory creation and storage. A document storage and access system, as described herein, may include a document storage and access (“DSA”) computer device that is in communication with a user computer device. The DSA computer device may be configured to: 1) register a group of users through an application, wherein each user of the group of users is associated with a client device; (2) display, via a first client device, a question to at least a first user of the group of users; (3) receive, from the first client device, a first video captured by the first client device in response to the question; (4) transmit to at least a second client device, a link to view the first video, wherein the second client device is configured to display the first video; (5) receive, from the second client device, a second video captured by the second client device in response to the first video; and (6) associate the second video with the first video.

In one aspect, a computer system for memory creation and storage system may be provided. The computer system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer system may be programmed to: (1) register a group of users through an application, wherein each user of the group of users is associated with a client device; (2) display, via a first client device, a question to at least a first user of the group of users; (3) receive, from the first client device, a first video captured by the first client device in response to the question; (4) transmit to at least a second client device, a link to view the first video, wherein the second client device is configured to display the first video; (5) receive, from the second client device, a second video captured by the second client device in response to the first video; and (6) associate the second video with the first video. The computer system may have additional, less, or alternate functionality, including that discussed elsewhere herein.

In another aspect, a computer-implemented method for memory creation and storage system may be provided. The computer-implemented method may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer-implemented method may be implemented using one or more local or remote processors, transceivers, and memory units, configured for wireless communication and/or data transmission over one or more radio frequency links, and the method may include: (1) displaying, via a first client device, a prompt to a first user; (2) receiving, from the first client device, a first response captured by the first client device in response to the prompt; (3) transmitting to at least a second client device, a link to view the first response, wherein the second client device is configured to display the first response; (4) receiving, from the second client device, a second response captured by the second client device in response to the first response; and/or (5) associating the second response with the first response. The method may include additional, less, or alternate actions, including those discussed elsewhere herein.

In a further aspect, at least one non-transitory computer-readable media having computer-executable instructions embodied thereon may be provided. When executed by a computing device including at least one processor in communication with at least one memory device, the computer-executable instructions may cause the at least one processor to: (1) register a group of users through an application, wherein each user of the group of users is associated with a client device; (2) display, via a first client device, a question to at least a first user of the group of users; (3) receive, from the first client device, a first video captured by the first client device in response to the question; (4) transmit to at least a second client device, a link to view the first video, wherein the second client device is configured to display the first video; (5) receive, from the second client device, a second video captured by the second client device in response to the first video; and (6) associate the second video with the first video. The computer-executable instructions may direct additional, less, or alternate functionality, including that discussed elsewhere herein.

The present embodiments may also relate to systems and methods for multimedia document relational storage and retrieval. A document storage and access system, as described herein, may include a document storage and access (“DSA”) computer device that is in communication with a user computer device. The DSA computer device may be configured to (i) receive a plurality of documents; (ii) for one or more documents of the plurality of documents, receive an indication of a first individual associated with the one or more documents; (iii) generate a first profile for the first individual based upon the one or more documents associated with the first individual; (iv) receive a further document associated with the first individual; (v) link the further document to the first profile for the first individual; (vi) receive a request for information associated with the first individual; and/or (vii) provide a plurality of documents linked to the first profile of the first individual. Further, the DSA computer device may be configured to create a plurality of links between a plurality of documents and profiles associated with individuals, events, locations, and other features so that users may interact with the information and collect the documents associated with the desired individual, etc.

In one aspect, a computer system for multimedia document relational storage and retrieval may be provided. The computer system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer system may include at least one processor (and/or associated transceiver) in communication with at least one memory device. The at least one processor may be configured or programmed to: (1) receive a plurality of documents; (2) for one or more documents of the plurality of documents, receive an indication of a first individual associated with the one or more documents; (3) generate a first profile for the first individual based upon the one or more documents associated with the first individual; (4) receive a further document associated with the first individual; (5) link the further document to the first profile for the first individual; (6) receive a request for information associated with the first individual; and/or (7) provide a plurality of documents linked to the first profile of the first individual. The computer system may have additional, less, or alternate functionality, including that discussed elsewhere herein.

In another aspect, a computer-based method for multimedia document relational storage and retrieval may be provided. The method may be implemented on a document storage and access (“DSA”) server that includes at least one processor (and/or associated transceiver) in communication with at least one memory device. The method may include, via the at least one processor: (1) receiving a plurality of documents; (2) for one or more documents of the plurality of documents, receiving an indication of a first individual associated with the one or more documents; (3) generating a first profile for the first individual based upon the one or more documents associated with the first individual; (4) receiving a further document associated with the first individual; (5) linking the further document to the first profile for the first individual; (6) receiving a request for information associated with the first individual; and/or (7) providing a plurality of documents linked to the first profile of the first individual. The method may include additional, less, or alternate actions, including those discussed elsewhere herein.

In yet another aspect, at least one non-transitory computer-readable storage media having computer-executable instructions embodied thereon may be provided. When executed by at least one processor, the computer-executable instructions cause the processor to: (1) receive a plurality of documents; (2) for one or more documents of the plurality of documents, receive an indication of a first individual associated with the one or more documents; (3) generate a first profile for the first individual based upon the one or more documents associated with the first individual; (4) receive a further document associated with the first individual; (5) link the further document to the first profile for the first individual; (6) receive a request for information associated with the first individual; and/or (7) provide a plurality of documents linked to the first profile of the first individual. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1A is an exemplary screenshot of an example add a memory page of a document storage and access system illustrated in FIG. 7.

FIG. 1B is an exemplary screenshot of an example of a memory upload and confirmation page of the document storage and access system illustrated in FIG. 7.

FIG. 1C is an exemplary screenshot of an example of an add a comment page of the document storage and access system illustrated in FIG. 7.

FIG. 2 is an exemplary screenshot of an example library page for accessing memories in the document storage and access system illustrated in FIG. 7.

FIG. 3A is an exemplary screenshot of an example add a document upload page to the document storage and access system illustrated in FIG. 7.

FIG. 3B is an exemplary screenshot of an example of a document upload and confirmation page of the document storage and access system illustrated in FIG. 7.

FIG. 4 is an exemplary screenshot of an example library page for accessing documents in the document storage and access system illustrated in FIG. 7.

FIG. 5 illustrates a simplified block diagram of an exemplary flowchart for adding a memory using the document storage and access system illustrated in FIG. 7.

FIGS. 6A-6F illustrate exemplary screenshots of a data storage and access application executing by the document storage and access system shown in FIG. 7.

FIG. 7 illustrates a simplified block diagram of an exemplary data storage and access system in accordance with at least one embodiment.

FIG. 8 illustrates an exemplary configuration of a client computer device shown in FIG. 7, in accordance with one embodiment of the present disclosure.

FIG. 9 illustrates an exemplary configuration of a server shown in FIG. 7, in accordance with one embodiment of the present disclosure.

FIG. 10 illustrates an exemplary computer-implemented method of creating and storing related video memories using the data storage and access system shown in FIG. 7.

FIG. 11 illustrates an exemplary process for providing multimedia document relational storage and retrieval using the data storage and access system shown in FIG. 7.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for providing multimedia document relational storage and retrieval. A data storage and access system, as described herein, may include a Data Storage and Access (“DSA”) computer device that is in communication with a plurality of user computer devices. In an exemplary embodiment, the process is performed by Data Storage and Access (“DSA”) computer device, also known as a Data Storage and Access (“DSA”) server. In the exemplary embodiment, one or more user's desire to store multi-media files with annotations and connections between the files. For example, a user may desire to store an image with a plurality of individuals in the image. The user may wish to annotate the file with a listing of those individuals in the image. Furthermore, the user may wish to attach one or more additional documents to the image, such as by linking to an individual in the image. In one example, the file may be a video or audio file created of the individual in question. This information may be very useful for recording keeping and/or storing historical information.

In the exemplary embodiment, the DSA computing device is in communication with one or more storage hubs or databanks, which are databases of documents with their annotations and/or associations. The DSA computing device is able to store and determine linkages and relationships between different documents. In at least one embodiment, the DSA computing device may generate an inventory of the documents store associated with one or more users.

In the exemplary embodiment, the DSA computing device receives a document to store from a user via a user computer device. The document may include, but is not limited to, a text file, an audio file, a video file, an image file, a document scan, and/or any other file type that may work with the systems and methods disclosed herein. The DSA computing device stores the document, such as in a database. The DSA computing device may also receive information about the document to store with the document. In some embodiments, the received information is added to the metadata of the document. In other embodiments, the DSA computing device stores one or more linking or information files that tracks the additional information for the document and links that information back to the document.

In at least one embodiment, the DSA computing device allows the user to organize the documents. The DSA computing device may organize the documents by document type, document topic, document category, associated individuals, date/time, location, and/or other data based on the needs of the user. For example, a plurality of images may be organized by an associated event, such as, a wedding, a vacation, and/or an awards ceremony. Furthermore, each image may also indicate who is in the image. The DSA computing device may then allow the user to sort the images by individual, for example to see all of the images with John Smith in them at Amy and Rory's wedding.

In at least one embodiment, the DSA computing device may receive the name of an individual and then provide at least a portion of the documents associated with that individual to the user. For example, the DSA computing device receives the name John Smith and provides images with John Smith in them, text documents written by or mentioning John Smith, audio and/or video recordings with or about John Smith, and/or any other document available with an association to John Smith as indicated by the DSA computing device.

In some embodiments, different files may have different priority and/or security settings. In these embodiments, a user may have an access level, where the user is only allowed to view documents associated with their access level. In some of these embodiments, the user may only access files at or below their access level. In these embodiments, the DSA computing device filters out the documents that are associated with higher priorities that those that the user is able to access.

In at least one embodiment, the DSA computing device is programmed through machine learning (ML) and/or artificial intelligence (AI) to recognize one or more individuals in an image and annotate the image to indicate the image. For example, the DSA computing device may scan an image an recognize John Smith in the background of the image. Then the DSA computing device may annotate the image to indicate that John Smith is in the image and where in the image. When the image is displayed, the DSA computing device may name each individual in the image. The DSA computing device may also allow the user to hover a cursor over a portion of the image and indicate, such as in a tool tip or other pop-up, who is in that portion of the image.

In one of more embodiments, the DSA computing device generates and stores profiles for individuals, locations, and/or events and uses the profile to store information about the documents linked and/or associated with that individual, location and/or event. For example, the DSA computing device may store a profile for John Smith (individual), little wedding chapel (location), and Amy and Rory's wedding (event).

In a first implementation, the DSA system may be used for storing and organizing a family history. The DSA system may be used for capturing and curating personal memories and important end-of-life decisions, storing that information, and sharing those with loved ones and family members. The components of this DSA system include digital storytelling, planning, and cloud-based storage. The purpose of this system includes sharing memories through a legacy system to capture those family memories, and then sharing those memories and stories with family members. In this implementation, the users are family members who are trying to keep track of and share their family history. The images, audio, and/or videos in this implementation may be of family members and friends. The individuals with associations are fellow family members and friends. The DSA computing device may organize and present family albums with images, text documents, audio files, and/or video files associated with an individual and/or an event. For example, on a family member's birthday, the DSA computing device generates an album about the family member and sends links to the album to the family as a part of celebrating the family member's birthday.

Furthermore, in the family history implementation, the DSA computing device may also store copies of important family documents, such as, but not limited to, wills, bank account information, insurance policies, birth certificates, death certificates, baptism documents, marriage certificates, diplomas, and/or other important family documents to be securely stored. In at least one embodiment, these family documents are secured from being accessed and/or changes being made to them by unauthorized individuals. Furthermore, in the case of wills, bank account information, insurance policies, and other secure documents, the DSA computing device may track who accessed the document, when they accessed it, and/or if any changes were made. In some further embodiments, the DSA computing device may track which changes were made to the document.

In some embodiments, the DSA computing device also includes a plurality of health care information about one or more individuals. This information may be used to learn about the family's health condition and/or diseases, such as hereditary and non-hereditary health issues.

In still further embodiments, the DSA computing device may store one or more milestone messages that may be delivered after the creator has deceased. For example, a message from one's grandparent on their 50^{th} birthday after the grandparent has passed.

In a further embodiment of the family history implementation, the DSA computing device may be configured to prompt (via audio prompt, text prompt, video prompt, or other type of prompt) a user to respond to a question with a video response, an audio response, and/or a written response. Example questions may include, but are not limited to, “How does the world feel different from when you were a child?”; “What traits do you believe that you inherited from your parents?”; “Please share a funny story about your parents?”; and “What is a moment in your life that makes you smile when you think of it?” The user may then click on the question to respond, such as by a “video answer.” The mobile device that the user is using would then activate the camera that faces the user (e.g., selfie mode) to allow the user to record a video response to the questions. The mobile device may then compress the video/audio/writing and upload the compressed video to the DSA computing device for storage.

The DSA computing device may then ask the user if they wish to share the video/audio/writing. The user may provide the DSA computing device with one or more additional users that the original user desires the video/audio/writing be shared with. In at least one embodiment, the DSA computing device forwards a link to the video/audio/writing to the selected one or more additional users. In other embodiments, the DSA computing device may include an application that allows the one or more additional users to view the video/audio/writing in the application. In one of these embodiments, the DSA computing device displays an activity feed of videos/audios/writings to the one or more additional users. The one or more additional users may view the video by clicking on the corresponding item (e.g., icon representing the senior's video or video answer) in the activity feed. Furthermore, the one or more additional members may also answer the question with their own videos/audios/writings, comment on the user's video/audio/writing (either with text comments or their own videos/audios/writings), and/or “like” the video/audio/writing. In addition to comment videos/audios/writings, the one or more additional members may also create and upload reaction videos, where the individual user is recorded with the user facing camera, while they are watching a video. These reaction videos may be viewed on their own, or side-by-side with the original video created by the user. These additional videos/audios/writings may also be viewed and responded to by others.

The videos/audios/writings may be stored in a database that allows for the linking of the videos to each other and/or to specific questions or themes, and the display of the videos, comments, and questions in a conversation mode. The conversation mode display may display multiple videos where the videos are displayed linked to other videos. Furthermore, series of videos may be displayed indented from the videos that inspired them.

In some embodiments, videos may be linked together based upon the question that is answered (such as a life experience question or other prompt for information), the video that is responded to, the individuals in the video, additionally tagged individuals, and/or how the video is initiated.

In some embodiments, the person recording the video/audio/writing may upload one or more photos or other artifacts to be displayed with the video/audio/writing. These photos or artifacts may be displayed in at least a portion of the video, either as full screen or as an insert in the video. Furthermore, the artifacts and/or photos may be attached to video/audio/writing in storage so that they may be viewed on their own as well.

In a second implementation, the DSA system may be used for cataloging a museum or historical site. The users may provide information about the museum or site, the different objects stored at the site, their provenance, donor information, and other important information. For example, in an art museum, the DSA system may track the different works of art, their creators, history and/or stories about the works and/or their creators. This information could be available to visitors and those from outside of the museum. Many museums have multiple storage rooms that have large numbers of items that are not available for display either due to their condition and/or the available display space in the museum. By digitizing and sharing those items, the museum may greatly increase their availability to researchers and/or scientists.

In this implementation, the DSA computing device may also assist with donor outreach. The DSA computing device may determine how much each donor provided over a period of time, identify donors in images, such as from an event, and determine which pleas have had the most success.

At least one of the technical problems addressed by this system may include: (i) providing a central location for storing a plurality of information; (ii) improving indexing and accessing related information; (iii) improved speed and/or efficiency of searching and/or filtering data; (iv) reduced time for data queries; (v) improved retrieval of information; and/or (vi) secure storage of information.

The methods and systems described herein may be implemented by performing one of more of the steps of a) receive a plurality of documents; b) for one or more documents of the plurality of documents, receive an indication of a first individual associated with the one or more documents; c) generate a first profile for the first individual based upon the one or more documents associated with the first individual; d) receive a further document associated with the first individual; e) link the further document to the first profile for the first individual; f) receive a request for information associated with the first individual; g) provide a plurality of documents linked to the first profile of the first individual; h) receive an indication that a first document is associated with the first individual and a second individual; i) associate the first document with the first profile and a second profile associated with the second individual; j) analyze a second document to detect a potential association with the first individual; k) add the second document to the first profile based on the potential association; l) wherein the plurality of documents includes one or more of images, text files, audio files, video files, and/or scan files; m) wherein one or more documents of the plurality of documents are secure documents; n) wherein the secure documents include one or more of wills, bank account information, insurance policies, birth certificates, death certificates, baptism documents, marriage certificates, and diplomas, o) validate the user's access level before granting access to the one or more secure documents; p) store a plurality of profiles for a plurality of individuals including associations with the plurality of documents; q) store a plurality of attributes for each document of the plurality of documents; r) receive a request including at least one attribute of the plurality of attributes; s) filter the plurality of documents based on the at least one attribute in the request; and/or t) generate an album of documents associated with the first individual.

### Exemplary Application Screenshots

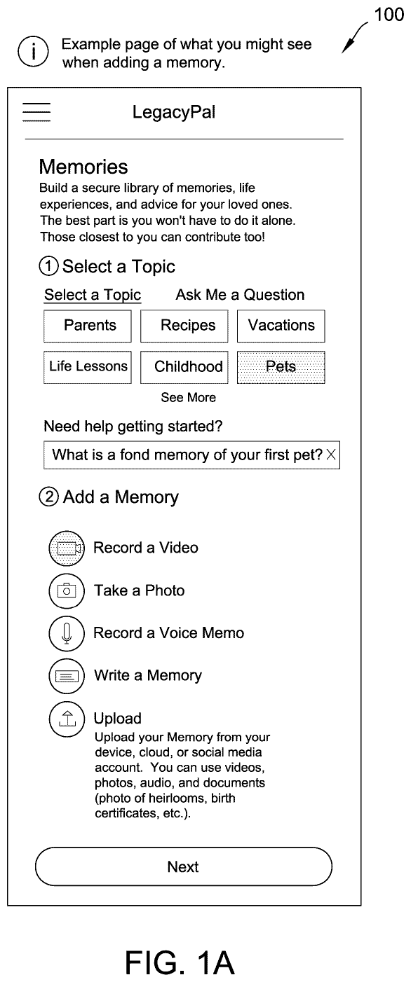

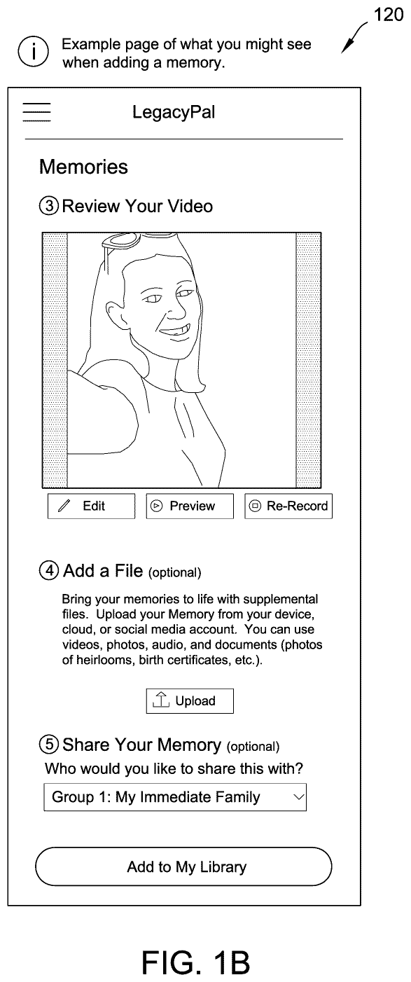

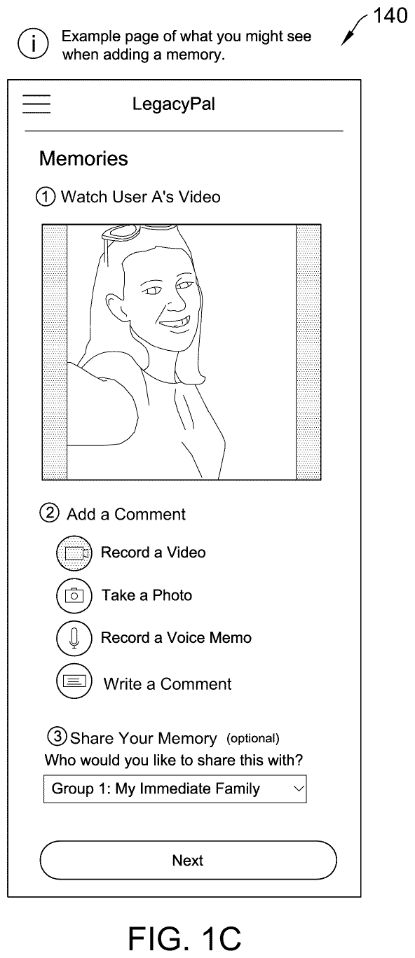

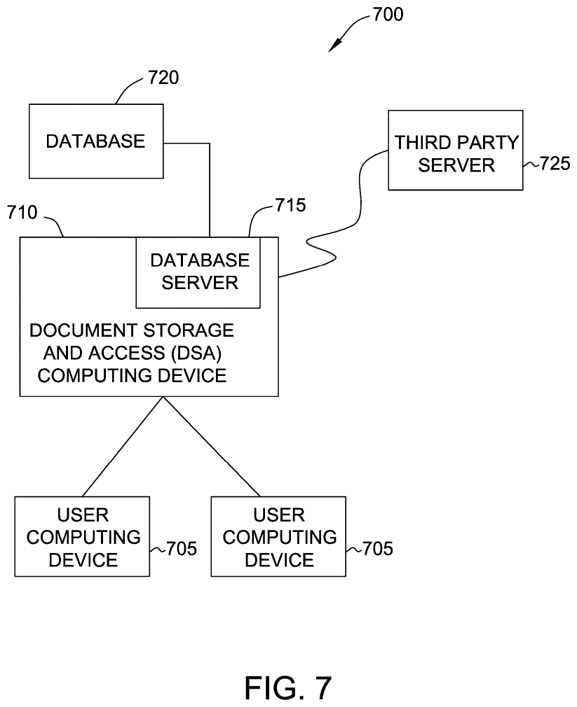

FIG. 1A is an exemplary screenshot of an example add a memory page 100 of a document storage and access system 700 illustrated in FIG. 7. The page 100 allows a user to add a memory, either by recording a video, taking a photo, recording an audio clip, writing a memory, or uploading a file of one of the types listed above. The page 100 also allows the user to select a topic for the memory.

FIG. 1B is an exemplary screenshot of an example of a memory upload and confirmation page 120 of the document storage and access system 700 illustrated in FIG. 7. Page 120 is displayed after a document has been created or uploaded. In this example page 120, the user has the option to review their video, the ability to add another file, and to determine who they wish to share the memory/file with.

FIG. 1C is an exemplary screenshot of an example of an add a comment page 140 of the document storage and access system 700 illustrated in FIG. 7. Page 140 is displayed to allow a user to access a video/audio/writing shared by another user. Page 140 also allows the user to provide a comment to the video/audio/writing that may then be shared back to the original user and potentially others. The page 140 allows a user to add a comment, either by recording a video, taking a photo, recording an audio clip, writing a memory, or uploading a file of one of the types listed above.

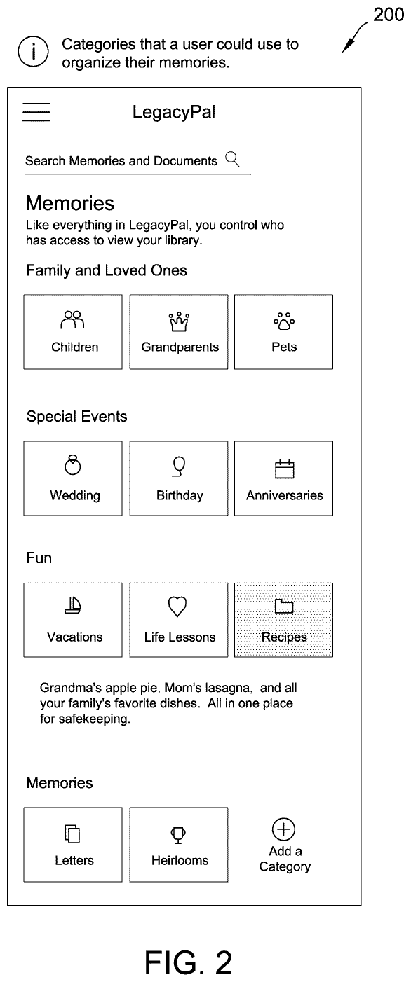

FIG. 2 is an exemplary screenshot of an example library page 300 for accessing memories in the document storage and access system 700 illustrated in FIG. 7. The library page 200 shows different types of memories based on individuals, events, activities, and/or mementos. The library page 200 allows the user access to the different memories stored in the different categories. In some situations, a memory may be stored in more than one category. For example, a trip to an amusement park may be stored in a vacations category and a children category.

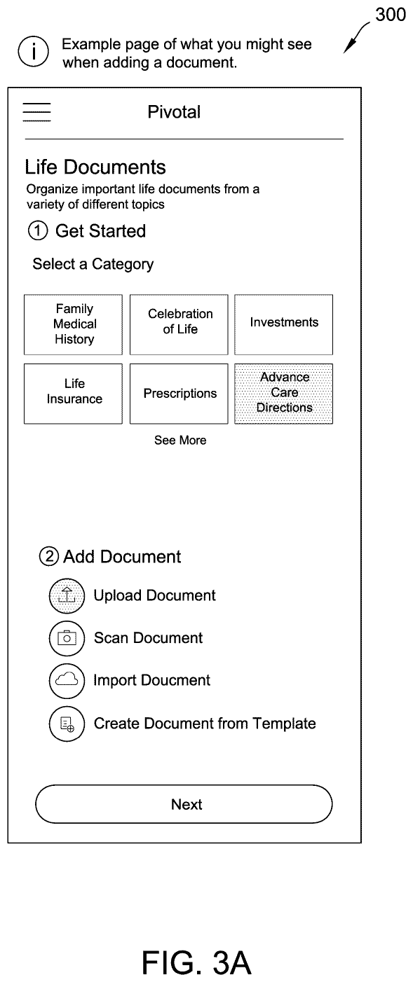

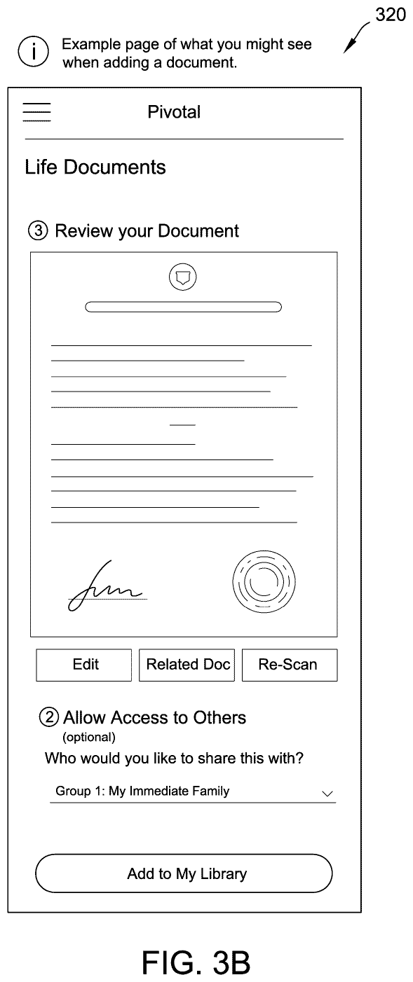

FIG. 3A is an exemplary screenshot of an example add a document upload page 300 to the document storage and access system 700 illustrated in FIG. 7. Upload page 300 allows the user to upload, scan, import, and/or create important documents. are secure documents. The secure documents may include one or more of wills, bank account information, insurance policies, birth certificates, death certificates, baptism documents, marriage certificates, and diplomas. In some of these embodiments, each user is associated with an access level to determine if they may access those documents. The upload page 300 also allows the user to select a category for the memory.

FIG. 3B is an exemplary screenshot of an example of a document upload and confirmation page 320 of the document storage and access system 700 illustrated in FIG. 7. Page 320 is displayed after a document has been created or uploaded. In this example page 320, the user has the option to review their document and determine who may have access to view the document.

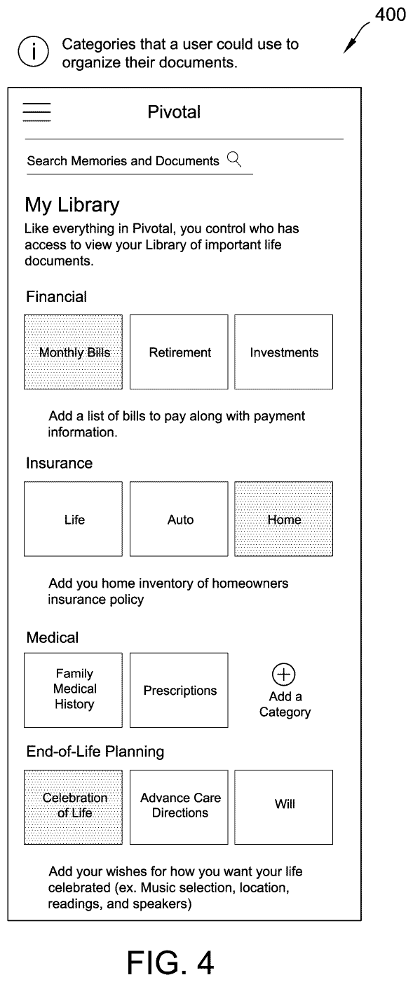

FIG. 4 is an exemplary screenshot of an example library page 400 for accessing documents in the document storage and access system 700 illustrated in FIG. 7. More specifically, library page 400 shows different types of documents that may be stored including financial documents, insurance documents, medical documents, and end-of-life planning documents. The library page 400 allows the user access to the different memories stored in the different categories.

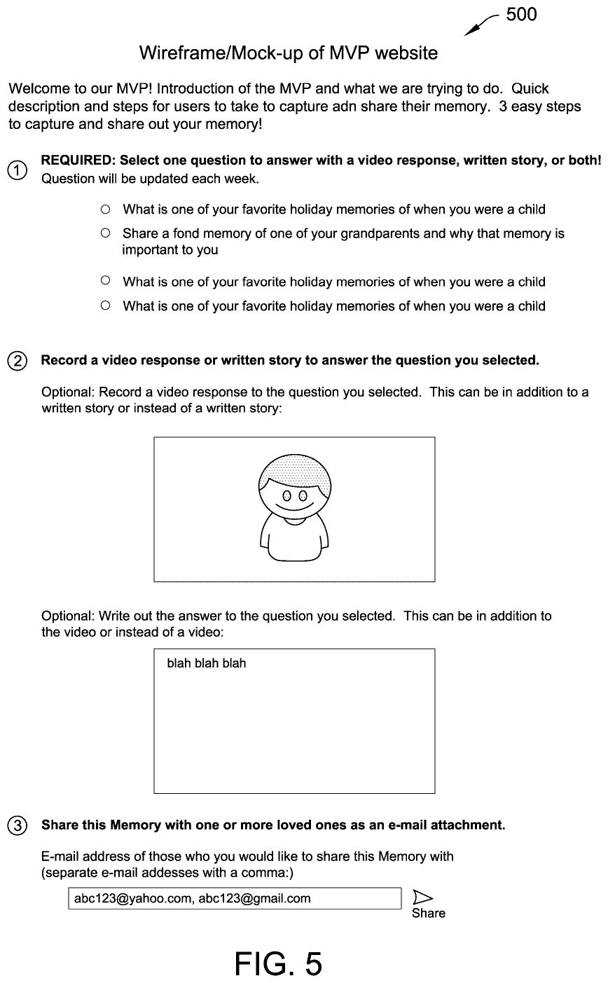

FIG. 5 illustrates a simplified block diagram of an exemplary flowchart 500 for adding a memory using the document storage and access system 700 illustrated in FIG. 7. In flowchart 500, the DSA system 700 assists a user in creating and storing a memory. The DSA system 700 prompts the user with a question or prompt about a memory to inspire the user into sharing a memory. In this example, the DSA system 700 provides multiple memory prompts for the user to respond to, such as “Share a food memory of one of your grandparents and why that memory is important to you.” The DSA system 700 allows the user to create a video response or a written response to the prompt. In some other embodiments, the DSA system 700 may also allow the user to create an audio response. Then the DSA system 700 allows the user to share the memory with one or more loved ones as an email.

In the exemplary embodiment, the DSA system also stores the memory and associates the memory with the user and the prompt that was answered.

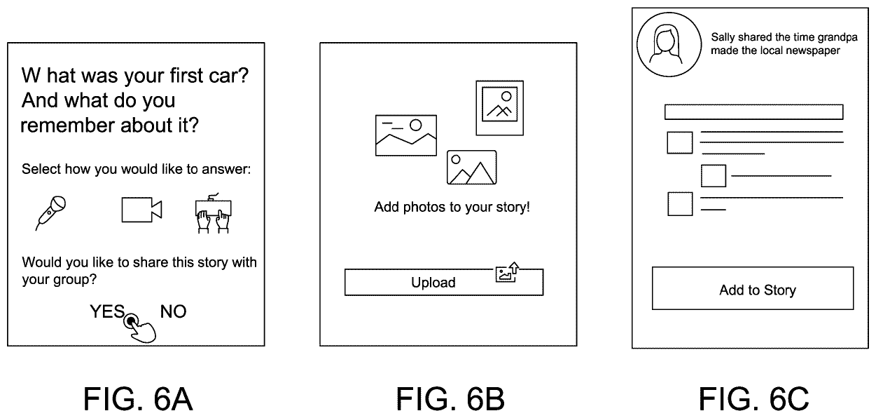

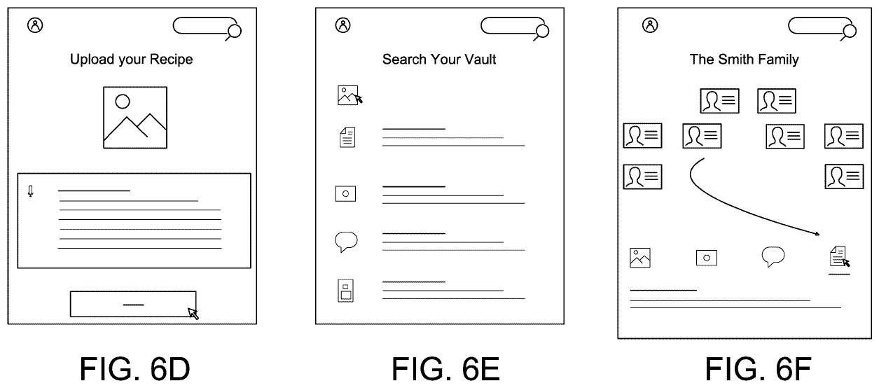

FIGS. 6A-6F illustrate exemplary screenshots of a data storage and access application executing by the document storage and access system 700 shown in FIG. 7. FIG. 6A illustrates a prompt that allows a user to create and store a memory either as an audio file, a video file, or a text document. The user may then share the completed file with a predetermined group of others. FIG. 6B illustrates allowing the user to add photos (or image files) to their story and/or memory. The photos may be used to enhance the story and/or memory. FIG. 6C illustrates a prompt that a user may receive when another user shared their story and/or memory with the user. The system 700 allows the user to add to the story, such as by describing the story from their point of view and/or adding details to the story. FIG. 6D illustrates a prompt to allow a user to upload their recipe.

FIG. 6E illustrates the system 700 allowing a user to search their vault of files, such as, images, audio, video, text, and other files. FIG. 6F illustrates the system allowing a user to organize their contacts in their family tree.

### Exemplary Computer Network

FIG. 7 depicts a simplified block diagram of an exemplary data storage and access system 700 in accordance with at least one embodiment. In the exemplary embodiment, system 700 may be used for providing multimedia document relational storage and retrieval. A data storage and access system 700, as described herein, may include a Data Storage and Access (“DSA”) server 710 that is in communication with a plurality of user computer devices 705. In the exemplary embodiment, one or more user's desire to store multi-media files with annotations and connections between the files. As described herein in more detail, a user may desire to store an image with a plurality of individuals in the image. The user may wish to annotate the file with a listing of those individuals in the image. Furthermore, the user may wish to attach one or more additional documents to the image, such as by linking to an individual in the image. As described herein in more detail, a Data Storage and Access (“DSA”) server 710 may be configured to (1) receive a plurality of documents; (2) for one or more documents of the plurality of documents, receive an indication of a first individual associated with the one or more documents; (3) generate a first profile for the first individual based upon the one or more documents associated with the first individual; (4) receive a further document associated with the first individual; (5) link the further document to the first profile for the first individual; (6) receive a request for information associated with the first individual; and/or (7) provide a plurality of documents linked to the first profile of the first individual.

In the exemplary embodiment, user computer devices 705 are computers that include a web browser or a software application, which enables user computer devices 705 to access DSA server 710 using the Internet. More specifically, user computer devices 705 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 705 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, or other web-based connectable equipment or mobile devices.

A database server 715 may be communicatively coupled to a database 720 that stores data. In one embodiment, database 720 may include document files, secure files images, videos, and information about individuals in those files. In the exemplary embodiment, database 720 may be stored remotely from DSA server 710. In some embodiments, database 720 may be decentralized. In the exemplary embodiment, a person may access database 720 via user computer devices 705 by logging onto DSA server 710, as described herein.

DSA server 710 may be communicatively coupled with one or more the user computer devices 705. In some embodiments, DSA server 710 may be associated with, or is part of a computer network associated with an insurance provider, or in communication with the insurance provider's computer network (not shown). In other embodiments, DSA server 710 may be associated with a third party and is merely in communication with the insurance provider's computer network.

Third-party servers 725 may be any third-party server that DSA server 710 is in communication with that provides additional functionality and/or information to DSA server 710. For example, third-party server 725 may provide images and/or other information. In the exemplary embodiment, third-party servers 725 are computers that include a web browser or a software application, which enables third-party servers 725 to communicate with DSA server 710 using the Internet, a local area network (LAN), or a wide area network (WAN). In some embodiments, the third-party servers 725 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 725 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

### Exemplary Client Device

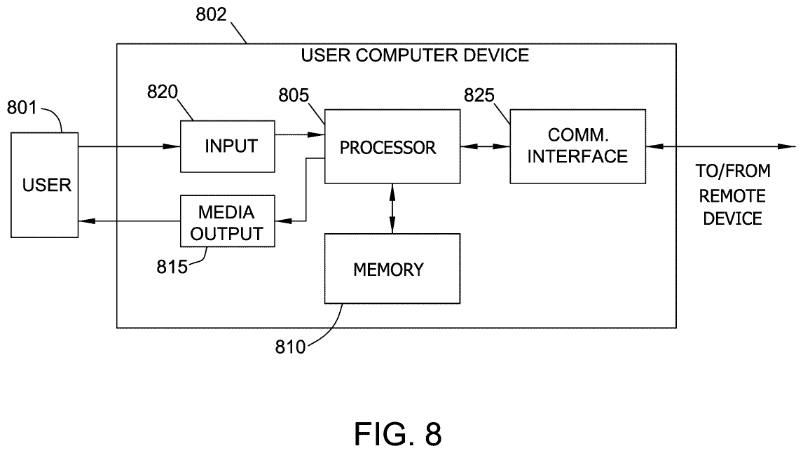

FIG. 8 depicts an exemplary configuration of a user computer device 705 shown in FIG. 7, in accordance with one embodiment of the present disclosure. User computer device 802 may be operated by a user 801. User computer device 802 may include, but is not limited to, user computer devices 705 (shown in FIG. 7). User computer device 802 may include a processor 805 for executing instructions. In some embodiments, executable instructions are stored in a memory area 810. Processor 805 may include one or more processing units (e.g., in a multi-core configuration). Memory area 810 may be any device allowing information such as executable instructions and/or transaction data to be stored and retrieved. Memory area 810 may include one or more computer readable media.

User computer device 802 may also include at least one media output component 815 for presenting information to user 801. Media output component 815 may be any component capable of conveying information to user 801. In some embodiments, media output component 815 may include an output adapter (not shown) such as a video adapter and/or an audio adapter. An output adapter may be operatively coupled to processor 805 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets).

In some embodiments, media output component 815 may be configured to present a graphical user interface (e.g., a web browser and/or a client application) to user 801. A graphical user interface may include, for example, an online interface for viewing and/or uploading images and/or videos. In some embodiments, user computer device 802 may include an input device 820 for receiving input from user 801. User 801 may use input device 820 to, without limitation, select and/or enter one or more documents to upload and/or view.

Input device 820 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 815 and input device 820.

User computer device 802 may also include a communication interface 825, communicatively coupled to a remote device such as the DSA server 710 (shown in FIG. 7). Communication interface 825 may include, for example, a wired or wireless network adapter and/or a wireless data transceiver for use with a mobile telecommunications network.

Stored in memory area 810 are, for example, computer readable instructions for providing a user interface to user 801 via media output component 815 and, optionally, receiving and processing input from input device 820. A user interface may include, among other possibilities, a web browser and/or a client application. Web browsers enable users, such as user 801, to display and interact with media and other information typically embedded on a web page or a website from the DSA server 710 and/or the third-party server 725. A client application allows user 801 to interact with, for example, the DSA server 710 and/or the third-party server 725. For example, instructions may be stored by a cloud service, and the output of the execution of the instructions sent to the media output component 815.

Processor 805 executes computer-executable instructions for implementing aspects of the disclosure. In some embodiments, the processor 805 is transformed into a special purpose microprocessor by executing computer-executable instructions or by otherwise being programmed.

### Exemplary Server Device

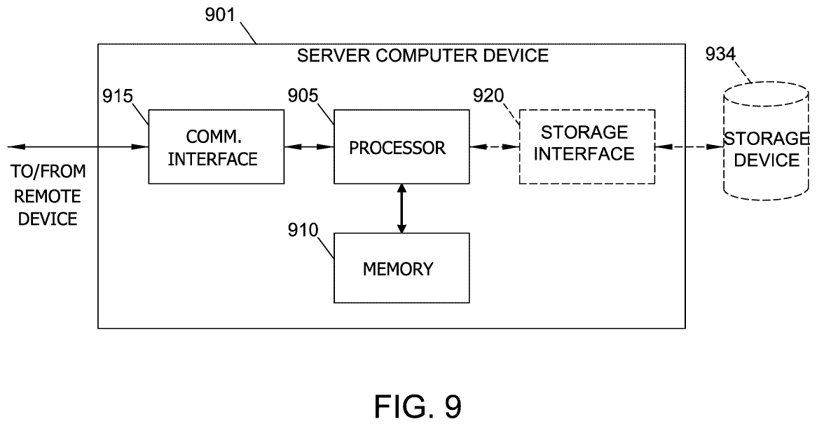

FIG. 9 depicts an exemplary configuration of a server 710 shown in FIG. 7, in accordance with one embodiment of the present disclosure. Server computer device 901 may include, but is not limited to, database server 715, DSA server 710, and third-party server 725 (all shown in FIG. 7). Server computer device 901 may also include a processor 905 for executing instructions. Instructions may be stored in a memory area 910. Processor 905 may include one or more processing units (e.g., in a multi-core configuration).

Processor 905 may be operatively coupled to a communication interface 915 such that server computer device 901 is capable of communicating with a remote device such as another server computer device 901, third-party server 725, or user computer devices 705 (shown in FIG. 7). For example, communication interface 915 may receive requests from user computer devices 705 via the Internet, as illustrated in FIG. 7.

Processor 905 may also be operatively coupled to a storage device 934. Storage device 934 may be any computer-operated hardware suitable for storing and/or retrieving data, such as, but not limited to, data associated with database 720 (shown in FIG. 7). In some embodiments, storage device 934 may be integrated in server computer device 901. For example, server computer device 901 may include one or more hard disk drives as storage device 934.

In other embodiments, storage device 934 may be external to server computer device 901 and may be accessed by a plurality of server computer devices 901. For example, storage device 934 may include a storage area network (SAN), a network attached storage (NAS) system, and/or multiple storage units such as hard disks and/or solid-state disks in a redundant array of inexpensive disks (RAID) configuration.

In some embodiments, processor 905 may be operatively coupled to storage device 934 via a storage interface 920. Storage interface 920 may be any component capable of providing processor 905 with access to storage device 934. Storage interface 920 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 905 with access to storage device 934.

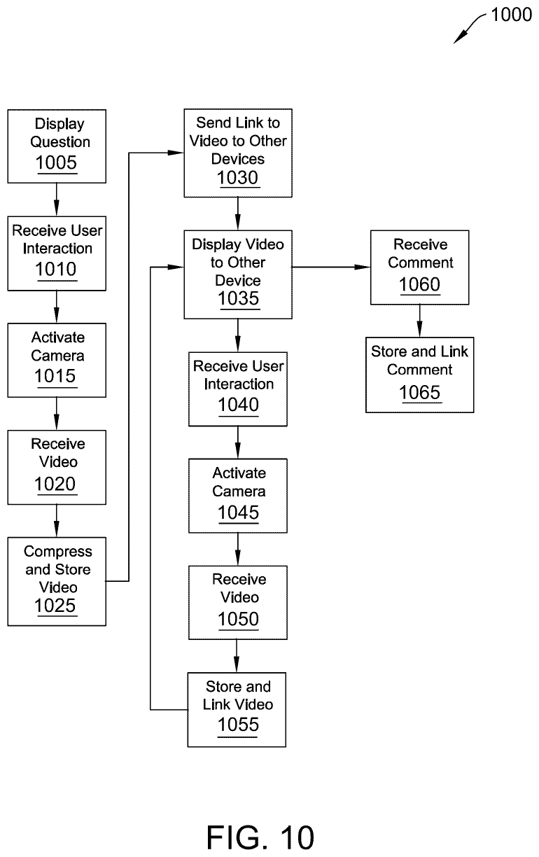

Processor 905 may execute computer-executable instructions for implementing aspects of the disclosure. In some embodiments, the processor 905 may be transformed into a special purpose microprocessor by executing computer-executable instructions or by otherwise being programmed. For example, the processor 905 may be programmed with the instructions such as illustrated in FIGS. 5 and 10.

In one example embodiment, the information may include, but is not limited to, family memories, family stories, family recipes, important documents, videos and audio of different family members telling stories, photographs with the subjects identified, and/or other family information.

### Exemplary Video Memory Creation & Storage

FIG. 10 illustrates an exemplary computer-implemented method 1000 of creating and storing related video/audio/written memories using the data storage and access system 700 (shown in FIG. 7). The computer-implemented method 1000 may be implemented via one or more processors, transceivers, servers, sensors, applications, mobile applications, chatbots (or voice-bots), and related technologies. In some embodiments, method 1000 may be carried out by the data storage and access (DSA) system 700. In some further embodiments, the DSA system 700 may be associated with and/or a part of a social media platform.

In the exemplary embodiment, a user computing device 705 (shown in FIG. 7) displays 1005 a question (or other prompt for information, such as described elsewhere herein). Exemplary questions may include, but are not limited to: “How does the world feel different from when you were a child?”; “What traits do you believe that you inherited from your parents?”; “Please share a funny story about your parents?”; and “What is a moment in your life that makes you smile when you think of it?” The question (such as a life experience questions discussed elsewhere herein) may include an option for the user to answer the question with video. An example of the question and answer option (such as “video answer”) may be seen in FIGS. 1A-1C.

The life experience questions (or other requests for information or stories) may be provided/pushed to the user (or other user) on a periodic basis. The questions may also be stored in a list or database, where the user may select one to answer or select a question to push to one of the others in the care circle group. Furthermore, individual users may ask or pose their own questions to others or to the group as a whole.

The user computing device 705 may receive 1010 a user interaction, where the user presses the answer option. The user computing device 705 may then activate 1015 one or more user facing cameras to capture video of the user. The user computing device 705 may capture 1020 the video of the user answering the question. The user computing device 705 may also capture 1020 audio or a written response to the question or prompt. In some embodiments, the user may have a predefined period of time to answer the question. In other embodiments, the user presses a button to indicate that they are finished answering the question. In some further embodiments, the user has the option of re-recording or editing the video/audio/writing prior to saving or sharing the video/audio/writing.

In the exemplary embodiment, the video/audio/writing is transferred to the DSA server 710 or other server for storage. In some embodiments, the DSA server 710 compresses and stores 1025 the video/audio/writing. In some further embodiments, the user computing device 705 compresses the video/audio/writing before transmitting to the DSA server 710. In some embodiments, the user computing device 705 compresses the video using a video compressor. In other embodiments, user computing device 705 compresses the video/audio/writing by removing one or more periods of quiet space, such as if the user spends some time thinking about the answer before answering, or if the user pauses during their answer.

In some embodiments, the user may upload one or more additional files to go with the video/audio/writing. These may include videos, photos, audio, and/or documents, including, but not limited to, photos or heirlooms, birth certificates, etc. In some of these embodiments, the user may upload the one or more files from their user computing device 705, the cloud, and/or a social media account.

In the exemplary embodiment, the DSA server 710 stores the video/audio/writing in a database 720 (shown in FIG. 7), where the video/audio/writing is linked to the question, any added files, and/or linked to a social networking application or other “story videos,” as discussed elsewhere herein. In some embodiments, there may be multiple videos linked to the same question (or topic, such as Family History). The database 720 may also store multiple questions, each with one or more videos/audios/writings attached to the question.

In the exemplary embodiment, the DSA server 710 transmits 1030 a link to the video/audio/writing to be displayed by various connected user computing devices 705. In at least one embodiment, the user choses who the link is transmitted 1030 to. In some embodiments, the DSA server 710 stores a plurality of contacts for the user. These contacts may be organized into groups, such as, but not limited to, immediate family, college friends, high school friends, etc. When a group is selected, the DSA server 710 transmits 1030 the link to all of the contacts in that group.

The user computing device 705 may display the link (and/or an associated video-related icon) in an activity feed. The link allows the user of that user computing device 705 to view the video.

In some embodiments, the link takes the viewer to a different screen or pop-up screen to display 1035 the video/audio/writing to the viewer. The viewer may have the option to respond to the video/audio/writing with a text-based comment and/or a follow-up video/audio/writing. In some embodiments, the viewer may also receive the option of creating a reaction video, where the viewer's user computing device 705 will use the user facing camera to record the viewer while they are watching the video. In a reaction video, the individual user is recorded with the user facing camera, while they are watching a video. These reaction videos may be viewed on their own or side-by-side with the original video. These additional videos may be viewed and responded to by others.

In some embodiments, the user computing device 705 may receive 1040 a user interaction, where the viewer selects an option to create a follow-up or response video in response to the original video. The user computing device 705 activates 1045 the camera and captures 1050 the video. The user computing device 705 then uploads the video to the DSA server 710, where the DSA server 710 stores and links 1055 the video to the previous video. Then the method 1000 allows the link of the new video to be transmitted 1030 to the other user computing devices 705 as a response to or a comment on the first video. The user computing device 705 may then display an option to view the response video, either in the activity feed or as an option when the viewer has selected the original video.

In other embodiments, the user computing device 705 may receive 1060 a text comment from the viewer. The user computing device 705 forwards the comment to the DSA server 710. The DSA server 710 stores the comment and links 1065 the comment to the viewed video. The user computing device 705 may then display an option to view the text comment, either in the activity feed or as an option when the viewer has selected the original video/audio/writing.

In some embodiments, the user computing device 705 and/or DSA server 710 may indicate which individuals have viewed any specific video/audio/writing. Furthermore, the user computing device 705 and/or DSA server 710 may indicate how many times each video/audio/writing has been viewed. In some embodiments, the user computing device 705 and/or DSA server 710 may also keep track of a number of likes or other reactions that each video/audio/writing has received from viewers.

In some embodiments, the user computing device 705 may allow a user to upload one or more images into the video/audio/writing. For example, the user may select an image to be displayed during their video/audio/writing. The image could be displayed over the entire screen or only on a portion of the screen. The image may also only be displayed for a specific period of time. For example, the image could be of a relative and the user has the image of the relative displayed while they are talking about that relative. The user may press a button or other option to tell the user computing device 705 when to start and when to end displaying the image. Furthermore, the user may have several images that are show at different times within the video/audio/writing. The images may also be stored with the video, such that an individual may view the image by selecting the image, rather than only when the video/audio/writing is playing.

In some embodiments, the user computing device 705 and/or DSA server 710 may allow the user to forward their video/audio/writing or another person's video/audio/writing to one or more other platforms, such as social media platforms and/or blogs. The user computing device 705 and/or DSA server 710 may allow the user to tag one or more individuals that are discussed in the video/audio/writing, so that those individuals may be notified of their appearance in a video/audio/writing. Furthermore, this tag may allow future viewers to filter videos/audios/writings based upon the individual to get stories about the desired individual. The user computing device 705 and/or DSA server 710 may request permission from the individual who recorded the video before allowing the video/audio/writing to be shared with an outside individual, application, and/or platform.

In some embodiments, the DSA server 710 may select, determine, generate, or create a question to ask the user. This questions selection or generation may be based upon calendar and upcoming holidays, user selections and/or preferences, and/or random selection. In some other embodiments, individuals may select or create a question to ask the user. In still further embodiments, individuals may ask the question in a video. For example, a video of one or more grandchildren asking the question may be forwarded and presented to the user or other appropriate individual.

In some embodiments, the DSA server 710 may store the video/audio/writing and comments to allow for easy navigation. The video/audio/writing are linked together based upon how they are related to the other videos/audios/writings (e.g., which video was in response to which other video/audio/writing). In some of these embodiments, the videos/audios/writings are graphically displayed as conversations, where response videos are displayed indented in from the original videos/audios/writings (such as indented to the right). The conversation display may show which videos/audios/writings came first, which ones were made in response, and allow the user to follow through the threads of comments.

In further embodiments, the DSA server 710 may edit and combine a plurality of videos/audios/writings into a longer compiled video/audio/writing by linking the question and answers in a conversation of videos/audios/writings. In some of these embodiments, the DSA server 710 may edit the video/audio themselves to remove time where nothing is said or remove a plurality of ‘umms’ from the video/audio. The DSA server 710 may do this based upon one or more user preferences (such as user preferences selected from editing menu or list).

The user computing device 705 may be a smart phone, a tablet, a laptop, a desktop, or other computer device with a screen and a camera. In some embodiments, the user may stream the video to another device, such as a smart television.

While the above is described in relation to the DSA system 700, method 1000 may also be performed as a part of a social media platform or other content sharing system or platform.

### Exemplary Processes for Data Storage and Retrieval

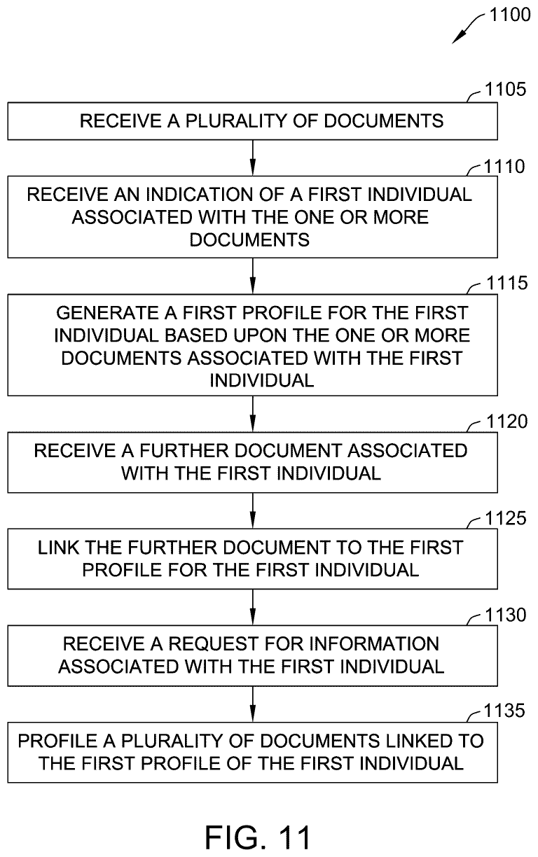

FIG. 11 illustrates an exemplary process 1100 for providing multimedia document relational storage and retrieval using the data storage and access system 700 (shown in FIG. 7). In the exemplary embodiment, process 1100 is performed by DSA server 710 (shown in FIG. 7).

In the exemplary embodiment, the DSA server 710 receives 1105 a plurality of documents. The plurality of documents includes one or more of images, text files, audio files, video files, and/or scan files.

For one or more documents of the plurality of documents, the DSA server 710 receives 1110 an indication of a first individual associated with the one or more documents.

In the exemplary embodiment, the DSA server 710 generates 1115 a first profile for the first individual based upon the one or more documents associated with the first individual.

In the exemplary embodiment, the DSA server 710 receives 1120 a further document associated with the first individual.

In the exemplary embodiment, the DSA server 710 links 1125 the further document to the first profile for the first individual.

In the exemplary embodiment, the DSA server 710 receives 1130 a request for information associated with the first individual.

In the exemplary embodiment, the DSA server 710 provides 1135 a plurality of documents linked to the first profile of the first individual.

In some further embodiments, the DSA server 710 receives an indication that a first document is associated with the first individual and a second individual. The DSA server 710 associates the first document with the first profile and a second profile associated with the second individual.

In additional embodiments, the DSA server 710 analyzes a second document to detect a potential association with the first individual. The DSA server 710 adds the second document to the first profile based on the potential association.

In some embodiments, one or more documents of the plurality of documents are secure documents. The secure documents may include one or more of wills, bank account information, insurance policies, birth certificates, death certificates, baptism documents, marriage certificates, and diplomas. In some of these embodiments, each user is associated with an access level. The DSA server 710 validates the user's access level before granting access to the one or more secure documents.

In further embodiments, the DSA server 710 stores a plurality of profiles for a plurality of individuals including associations with the plurality of documents.

In additional embodiments, the DSA server 710 stores a plurality of attributes for each document of the plurality of documents. The DSA server 710 receives a request including at least one attribute of the plurality of attributes. The DSA server 710 filters the plurality of documents based on the at least one attribute in the request.

In other embodiments, the DSA server 710 generates an album of documents associated with the first individual.

### Exemplary Embodiments & Functionality

In one embodiment, a computer system for memory creation and storage system may be provided. The computer system may (1) register a group of users through an application, wherein each user of the group of users is associated with a client device; (2) display, via a first client device, a question to at least a first user of the group of users; (3) receive, from the first client device, a first video captured by the first client device in response to the question; (4) transmit to at least a second client device, a link to view the first video, wherein the second client device is configured to display the first video; (5) receive, from the second client device, a second video captured by the second client device in response to the first video; and (6) associate the second video with the first video. The computer system may have additional, less, or alternate functionality, including that discussed elsewhere herein.

In some further enhancements, the computer system may receive a plurality of recipients from the first user. The computer system may also transmit the link to view the first response to the plurality of recipients.

In some further enhancements, the computer system may receive an additional file for the first response. The computer system may also transmit the link to the first response and the additional file to at least the second client device.

In some further enhancements, the first response is one of a video response, an audio response, and a written response. In additional enhancements, the second response is one of a video response, an audio response, and a written response. In other enhancements, the at least one processor is further programmed to store the first response with a link to the prompt.

In some further enhancements, the computer system may store the second response with a link to the first response. The computer system may also store a plurality of prompts in a memory. The computer system may further select the prompt to display to the first user. In addition, the computer system may receive, from a third client device, the prompt provided by a third user.

In some further enhancements, the computer system may receive, from a third client device, a third response of a third user responding to the second response. The computer system may also associate the third response with the second response. The computer system may further store the third response with a link to the second response. In addition, the computer system may transmit to at least the second client device and the first client device, a link to view the third response.

In some further enhancements, the computer system may receive a first comment to the first response. The computer system may further store the first comment with a link to the first response.

In some further enhancements, the computer system may export the first response to a social media platform.

In some aspects, the present embodiments may relate to a computer-implemented method for memory creation and storage system. The method may include, such as via one or more local or remote processors, transceivers, and memory units, configured for wireless communication and/or data transmission over one or more radio frequency links: (1) displaying, via a first client device, a prompt to a first user; (2) receiving, from the first client device, a first response captured by the first client device in response to the prompt; (3) transmitting to at least a second client device, a link to view the first response, wherein the second client device is configured to display the first response; (4) receiving, from the second client device, a second response captured by the second client device in response to the first response; and/or (5) associating the second response with the first response. The method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) register a group of users through an application, wherein each user of the group of users is associated with a client device; (2) display, via a first client device, a question to at least a first user of the group of users; (3) receive, from the first client device, a first video captured by the first client device in response to the question; (4) transmit to at least a second client device, a link to view the first video, wherein the second client device is configured to display the first video; (5) receive, from the second client device, a second video captured by the second client device in response to the first video; and (6) associate the second video with the first video. The computer-executable instructions may direct additional, less, or alternate functionality, including that discussed elsewhere herein.

In one embodiment, a computer system for multimedia document relational storage and retrieval may be provided. The computer system may (1) receive a plurality of documents; (2) for one or more documents of the plurality of documents, receive an indication of a first individual associated with the one or more documents; (3) generate a first profile for the first individual based upon the one or more documents associated with the first individual; (4) receive a further document associated with the first individual; (5) link the further document to the first profile for the first individual; (6) receive a request for information associated with the first individual; and/or (7) provide a plurality of documents linked to the first profile of the first individual. The computer system may have additional, less, or alternate functionality, including that discussed elsewhere herein.

In some further enhancements, the computer system may receive an indication that a first document is associated with the first individual and a second individual. The computer system may also associate the first document with the first profile and a second profile associated with the second individual.

In some further enhancements, the computer system may analyze a second document to detect a potential association with the first individual. The computer system may also add the second document to the first profile based on the potential association.

In some further enhancements, the plurality of documents includes one or more of images, text files, audio files, video files, and/or scan files.

In some additional enhancements, one or more documents of the plurality of documents may be secure documents. The secure documents may one or more of wills, bank account information, insurance policies, birth certificates, death certificates, baptism documents, marriage certificates, and diplomas. Each user is associated with an access level. The computer system may validate the user's access level before granting access to the one or more secure documents.

In some additional enhancements, the computer system may store a plurality of profiles for a plurality of individuals including associations with the plurality of documents.

In some additional enhancements, the computer system may store a plurality of attributes for each document of the plurality of documents. The computer system may also receive a request including at least one attribute of the plurality of attributes. The computer system may further filter the plurality of documents based on the at least one attribute in the request.

In some additional enhancements, the computer system may generate an album of documents associated with the first individual.

In some aspects, the present embodiments may relate to a computer-implemented method for multimedia document relational storage and retrieval. The method may include, such as via one or more local or remote processors, transceivers, and memory units, (1) receiving a plurality of documents; (2) for one or more documents of the plurality of documents, receiving an indication of a first individual associated with the one or more documents; (3) generating a first profile for the first individual based upon the one or more documents associated with the first individual; (4) receiving a further document associated with the first individual; (5) linking the further document to the first profile for the first individual; (6) receiving a request for information associated with the first individual; and/or (7) providing a plurality of documents linked to the first profile of the first individual. The method may include additional, less, or alternate actions, including those discussed elsewhere herein.

In some further enhancements, the method may include receiving an indication that a first document is associated with the first individual and a second individual. The method may also include associating the first document with the first profile and a second profile associated with the second individual.

In some further enhancements, the method may include analyzing a second document to detect a potential association with the first individual. The method may also include adding the second document to the first profile based on the potential association.

In some further enhancements, the plurality of documents includes one or more of images, pictures, videos, text files, audio files, video files, and/or scan files.

In some additional enhancements, one or more documents of the plurality of documents may be secure documents. The secure documents may one or more of wills, bank account information, insurance policies, birth certificates, death certificates, baptism documents, marriage certificates, and diplomas. Each user is associated with an access level. The method may include validating the user's access level before granting access to the one or more secure documents.

In some additional enhancements, the method may include storing a plurality of profiles for a plurality of individuals including associations with the plurality of documents.

In some additional enhancements, the method may include storing a plurality of attributes for each document of the plurality of documents. The method may also include receiving a request including at least one attribute of the plurality of attributes. The method may further include filtering the plurality of documents based on the at least one attribute in the request.

In some additional enhancements, the method may include generating an album of documents associated with the first individual.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) receive a plurality of documents; (2) for one or more documents of the plurality of documents, receive an indication of a first individual associated with the one or more documents; (3) generate a first profile for the first individual based upon the one or more documents associated with the first individual; (4) receive a further document associated with the first individual; (5) link the further document to the first profile for the first individual; (6) receive a request for information associated with the first individual; and/or (7) provide a plurality of documents linked to the first profile of the first individual. The computer-executable instructions may direct additional, less, or alternate functionality, including that discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract relevant information for users from mobile device sensors, vehicle-mounted sensors, home-mounted sensors, and/or other sensor data, vehicle or home telematics data, image data, and/or other data.

Certain embodiments may employ one or more voice bots, chatbots, ChatGPT bots, or other bots, such as for inputting, outputting, editing, or revising content, such as images or videos. For instance, the voice bot or chatbot may employ supervised or unsupervised ML techniques, which may be followed by, and/or used in conjunction with, reinforced or reinforcement learning techniques. The voice bot or chatbot may also employ the techniques utilized for ChatGPT.

In one embodiment, a processing element may be trained by providing it with a large sample of conventional analog and/or digital, still and/or moving (i.e., video) image data, telematics data, and/or other data of belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing sensor data, vehicle or home telematics data, image data, mobile device data, and/or other data. For example, the processing element may learn, with the user's permission or affirmative consent, to identify the faces of individuals in images and/or video.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an example embodiment, the system is executed on a single computer system, without requiring a connection to a server computer. In a further example embodiment, the system is being run in a Windows®environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system comprising at least one processor in communication with at least one memory device, wherein the at least one processor is programmed to:
receive a plurality of documents;
for one or more documents of the plurality of documents, receive an indication of a first individual associated with the one or more documents;
generate a first profile for the first individual based upon the one or more documents associated with the first individual;
receive a further document associated with the first individual;
link the further document to the first profile for the first individual;
receive a request for information associated with the first individual; and
provide a plurality of documents linked to the first profile of the first individual.

2. The computer system of claim 1, wherein the at least one processor is further programmed to:
receive an indication that a first document is associated with the first individual and a second individual; and
associate the first document with the first profile and a second profile associated with the second individual.

3. The computer system of claim 1, wherein the at least one processor is further programmed to:
analyze a second document to detect a potential association with the first individual; and
add the second document to the first profile based on the potential association.

4. The computer system of claim 1, wherein the plurality of documents includes one or more of images, text files, audio files, video files, and/or scan files.

5. The computer system of claim 1, wherein one or more documents of the plurality of documents are secure documents.

6. The computer system of claim 5, wherein the secure documents include one or more of wills, bank account information, insurance policies, birth certificates, death certificates, baptism documents, marriage certificates, and diplomas.

7. The computer system of claim 5, wherein each user is associated with an access level and wherein the at least one processor is further programmed to validate the user's access level before granting access to the one or more secure documents.

8. The computer system of claim 1, wherein the at least one processor is further programmed to store a plurality of profiles for a plurality of individuals including associations with the plurality of documents.

9. The computer system of claim 1, wherein the at least one processor is further programmed to:
store a plurality of attributes for each document of the plurality of documents;
receive a request including at least one attribute of the plurality of attributes; and
filter the plurality of documents based on the at least one attribute in the request.

10. The computer system of claim 1, wherein the at least one processor is further programmed to generate an album of documents associated with the first individual.

11. A computer-implemented method performed by a data storage and access (DSA) computer device including at least one processor in communication with at least one memory device, the method comprising:
receiving a plurality of documents;
for one or more documents of the plurality of documents, receiving an indication of a first individual associated with the one or more documents;
generating a first profile for the first individual based upon the one or more documents associated with the first individual;
receiving a further document associated with the first individual;
linking the further document to the first profile for the first individual;
receiving a request for information associated with the first individual; and
providing a plurality of documents linked to the first profile of the first individual.

12. The computer-implemented method of claim 11 further comprising:
receiving an indication that a first document is associated with the first individual and a second individual; and
associating the first document with the first profile and a second profile associated with the second individual.

13. The computer-implemented method of claim 11 further comprising:
analyzing a second document to detect a potential association with the first individual; and
adding the second document to the first profile based on the potential association.

14. The computer-implemented method of claim 11, wherein the plurality of documents includes one or more of images, text files, audio files, video files, and/or scan files.

15. The computer-implemented method of claim 11, wherein one or more documents of the plurality of documents are secure documents.

16. The computer-implemented method of claim 15, wherein the secure documents include one or more of wills, bank account information, insurance policies, birth certificates, death certificates, baptism documents, marriage certificates, and diplomas.

17. The computer-implemented method of claim 15, wherein each user is associated with an access level and wherein the method further comprises validating the user's access level before granting access to the one or more secure documents.

18. The computer-implemented method of claim 15 further comprising storing a plurality of profiles for a plurality of individuals including associations with the plurality of documents.

19. The computer-implemented method of claim 15 further comprising:
storing a plurality of attributes for each document of the plurality of documents;
receiving a request including at least one attribute of the plurality of attributes; and
filtering the plurality of documents based on the at least one attribute in the request.

20. At least one non-transitory computer-readable media having computer-executable instructions embodied thereon, wherein when executed by a computing device including at least one processor in communication with at least one memory device, the computer-executable instructions cause the at least one processor to:
receive a plurality of documents;
for one or more documents of the plurality of documents, receive an indication of a first individual associated with the one or more documents;
generate a first profile for the first individual based upon the one or more documents associated with the first individual;
receive a further document associated with the first individual;
link the further document to the first profile for the first individual;
receive a request for information associated with the first individual; and
provide a plurality of documents linked to the first profile of the first individual.
